(19) United States
(12) Patent Application Publication
(10) Pub. No.: US 2009/0050695 A1
(43) Pub. Date: Feb. 26, 2009

(54) EFFICIENT ACCESS RULES ENFORCEMENT MECHANISM FOR LABEL-BASED ACCESS CONTROL

(75) Inventors: Jihong Ma, Olathe, KS (US); Walid Rjaibi, Markham (CA)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/841,482

(22) Filed: Aug. 20, 2007

(51) Int. Cl. G06K 5/00

(52) U.S. Cl. 235/382

(57) ABSTRACT

A computer-program product for improving LBAC performance in a database may include assigning a security label to a user of a database. The security label may be one of multiple security labels associated with a security policy of the database. Each of the multiple security labels may then be compared to the user's security label to provide multiple comparison results. These comparison results may be stored in a persistent label comparison results table for later retrieval. Upon receiving a command to read or write to an object in the database, the comparison result associated with the object may be retrieved from the persistent label comparison results table. Access to the object may then be granted or denied based on the comparison result.

### BACKGROUND OF THE INVENTION

1. Field of the Invention

This invention relates to database access control and more particularly to mechanisms for increasing the efficiency of label-based access control (LBAC) in databases.

2. Description of the Related Art

Label-based access control (LBAC) is a relatively new security feature that uses security labels to designate who is authorized to read and write to rows and columns of a database table. Many organizations use LBAC implementations to classify and control access to data based on its sensitivity. LBAC may be used to assign security labels to data, which may in turn restrict access to users unless they have a security label equal to or greater than the data. LBAC may be used to construct security labels to represent the simplest to the most complex criteria an organization uses to control access to data.

To access a label-protected object, LBAC typically requires comparing the security label associated with the object to the security label granted to a subject (e.g., a user) attempting to access the object. When the LBAC-protected object is a row or column in a database table, significant processing overhead may be required to compare the security label of the object to the security label of the user. Nevertheless, in typical LBAC applications, a the number of unique security labels may be quite small (e.g., in the hundreds). Accordingly, it may be advantageous to store the results of the security label comparisons in a cache to reduce overhead and provide more rapid access to the results.

Some database systems (e.g., DB2 for z/OS) employ a cache in their LBAC implementations. This cache, however, suffers from various limitations. Specifically, the database system may still dedicate significant overhead to performing security label comparisons at run-time for every unique security label encountered. Moreover, the cache is typically not persistent. Thus, when the database connection is terminated, the cache is also terminated and the stored data is lost.

In view of the foregoing, what is needed is a solution to reduce the overhead associated with conventional LBAC caching. Ideally, such a solution would reduce or eliminate the need to perform security label comparisons at run-time and would enable the results of security label comparisons to persist across several database connections.

### SUMMARY OF THE INVENTION

The present invention has been developed in response to the present state of the art, and in particular, in response to the problems and needs in the art that have not yet been fully solved by currently available LBAC implementations. Accordingly, the present invention has been developed to improve LBAC performance in databases.

Consistent with the foregoing and in accordance with the invention as embodied and broadly described herein, one embodiment of a method to improve LBAC performance may include assigning a security label to a user of a database. The security label may be one of multiple security labels associated with a security policy of the database. Each of the multiple security labels may then be compared to the security label assigned to the user to provide multiple comparison results. These comparison results may be stored in a persistent label comparison results table for later retrieval. Upon receiving a command to read or write to an object in the database, the comparison result associated with the object may be retrieved from the persistent label comparison results table. Access to the object may then be granted or denied based on the comparison result.

In another aspect of the invention, an apparatus to improve LBAC performance in a database may include an assignment module to assign a security label to a user seeking to access a database. The security label may be one of multiple security labels associated with a security policy of the database. A comparator module may then compare the security label assigned to the user to each of the multiple security labels to provide multiple comparison results. These comparison results may be stored in a persistent label comparison results table for later retrieval.

A query module may be configured to receive, from the user, a command to read or write to an object in the database. Upon receiving the query, a retrieval module may retrieve a comparison result associated with the object from the persistent label comparison results table. A control module may then grant or deny access to the object based on the comparison result.

The present invention provides a novel apparatus and method to improve LBAC performance in a database. The features and advantages of the present invention will become more fully apparent from the following description and appended claims, or may be learned by practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 illustrates one embodiment of an apparatus to improve LBAC performance in a database;

FIG. 2 illustrates one embodiment of a database table for storing security labels associated with a security policy;

FIG. 3 illustrates one embodiment of a database table for storing security labels granted to users of a database; and

FIG. 4 illustrates one embodiment of a database table for storing label comparison results.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and provide the stated function of the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearance of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details may be provided, such as examples of programming, software modules, user selections, or the like, to provide a thorough understanding of embodiments of the invention. One skilled in the relevant art will recognize, however, that the invention may be practiced without one or more of the specific details, or with other methods or components. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

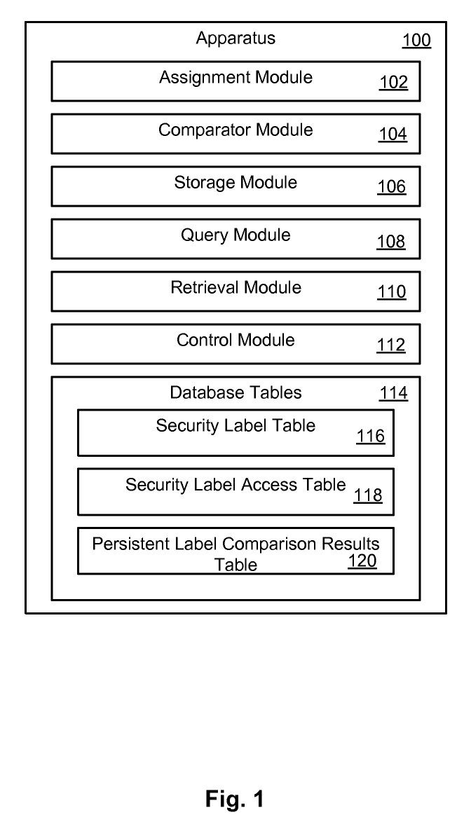

Referring to FIG. 1, one embodiment of an apparatus 100 to improve LBAC performance in a database is illustrated. As described above, the apparatus 100 may be implemented in hardware, software, firmware, or combinations thereof. In selected embodiments, the apparatus 100 may include an assignment module 102, a comparator module 104, a storage module 106, a query module 108, a retrieval module 110, a control module 112, as well as various database tables 114 or other files for storing information. The apparatus 100 may include each of the modules, or fewer or additional modules as needed to provide a desired functionality.

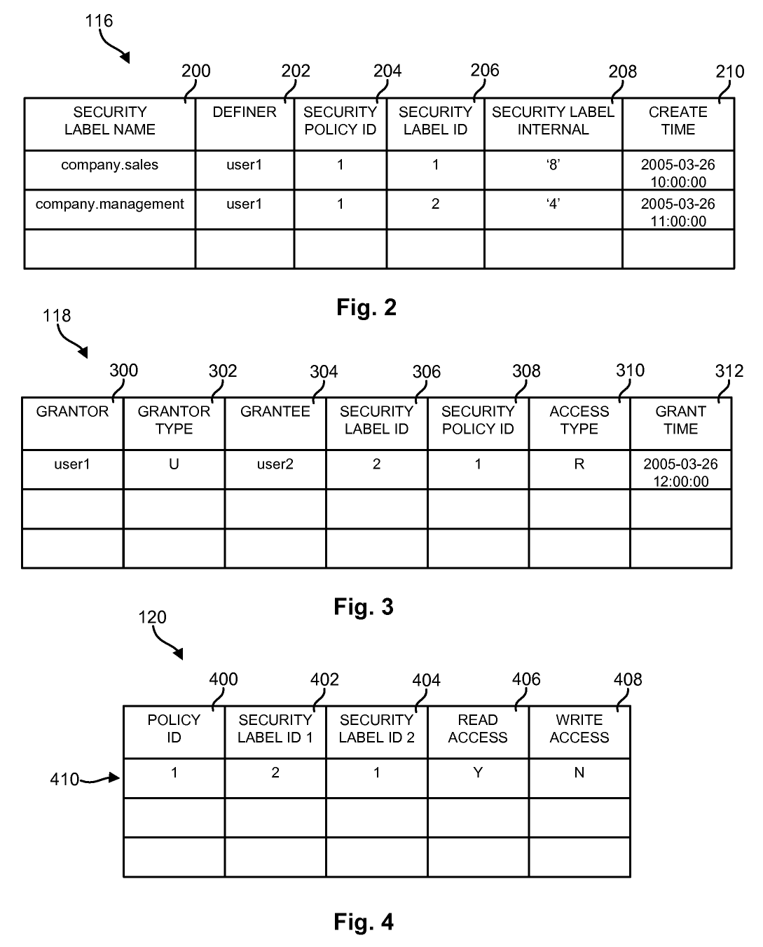

In selected embodiments, a security label table 116 may be used to store one or more security labels that may be associated with rows, columns, or other objects in a database. These security labels may also be assigned to users of the database to designate which users are authorized to read and write to label-protected rows and columns of the database. One embodiment of a security label table 116 is shown and will be described in association with FIG. 2.

In selected embodiments, an assignment module 102 maybe used to assign, or grant, one or more security labels in the security label table 116 to a user of the database. This may be accomplished, for example, by executing a GRANT SECURITY LABEL statement, which may grant a security label associated with a particular security policy to a user. Upon executing the statement, an entry corresponding to the user may be inserted into a security label access table 118, as will be explained in more detail in association with FIG. 3.

In selected embodiments, upon executing the GRANT SECURITY LABEL statement, a comparator module 104 may retrieve, from the security label table 116, each security label that has the same security policy ID as the security label assigned to the user. The comparator module 104 may then compare each of the security labels to the security label of the user. This may be accomplished by applying pre-established access rules to determine whether a user should have read or write access to certain types of security-label-protected data.

A storage module 106 may then store the comparison results in a persistent label comparison results table 120 for later retrieval. In selected embodiments, an entry may be created in the persistent label comparison results table 120 for each pair of security labels that are compared. The persistent label comparison results table 120 may reduce or eliminate the need to perform security label comparisons at run-time and may enable the comparisons results to persist across several database connections. One example of a persistent label comparison results table 120 in accordance with the invention will be described in association with FIG. 4.

Once the persistent label comparison results table 120 has been generated, a query module 108 may receive a query or other command from a user to read or write to an object in the database, such as would occur with a SELECT, DELETE, UPDATE, or INSERT command. Instead of comparing the user's security label to the object's security label, a retrieval module 110 may retrieve the corresponding comparison result from the persistent label comparison results table 120. A control module 112 may then use this comparison result to either grant or deny read and/or write access to the database object.

Referring to FIG. 2, one embodiment of a security label table 116 is illustrated. As shown, in selected embodiments, the table 116 may include columns to store a security label name 200, a definer 202 of the security label, a security policy ID 204 associated with the security label, a security label ID 206, the security label 208, and a create time 210 (i.e., timestamp) associated with the security label. For example, the following SQL statements may be used to create security labels named “company.management” and “company.sales” in the security label table 116, with each being associated with the “company” security policy (having a security policy ID of “1”) and having a different security label component assigned thereto:

CREATE SECURITY LABEL COMPONENT level
ARRAY [‘LEVEL 1’, ‘LEVEL 2’, ‘LEVEL 3’, ‘LEVEL 4’]
CREATE LABEL SECURITY POLICY company
COMPONENTS level
WITH DB2LBACRULES
CREATE SECURITY LABEL company.management
COMPONENT level ‘LEVEL 4’
CREATE SECURITY LABEL company.sales
COMPONENT level ‘LEVEL 2’

Referring to FIG. 3, after the security labels have been created, a GRANT SECURITY LABEL statement may be executed to assign one of the security labels to a user. For example, the security label “company.management” may be assigned to “user2” for read access by executing the following statement:

GRANT SECURITY LABEL company.management TO USER user2
FOR READ ACCESS

Upon executing this statement, an entry associated with “user2” may be created in the security label access table 118. In selected embodiments, this table 118 may include columns to store the security label grantor 300, the grantor type 302 (e.g., “U” where the grantor is a user or “R” where the grantor is a role), the grantee 304, the security label ID 306 associated with the assigned security label, the security policy ID 308 associated with the assigned security label, the access type 310 (e.g., “R” for read access, “W” for write access, or “B” for both read and write access), and a timestamp 312 corresponding to the time access was granted.

Referring to FIG. 4, upon granting a security label to a user for read or write access, each security label having the same security policy ID as the security label granted to the user may be retrieved from the security label table 116. Each of these security labels may then be compared to the user's security label to produce one or more comparison results. Each comparison result may then be stored as an entry in a persistent label comparison results table 120 or other file for later retrieval.

The persistent label comparison results table 120 may, in selected embodiments, include columns to store a policy ID 400, a first security label ID 402 (e.g., the security label ID granted to the user), a second security label ID 404, a read access indicator 406 (e.g., “Y” may designate that security label ID 1 can read security label ID 2 and “N” may designate that security label ID 1 cannot read security label ID 2), and a write access indicator 408 (e.g., “Y” may designate that security label ID 1 can write to security label ID 2 and “N” may designate that security label ID 1 cannot write to security label ID 2).

For example, referring to the security labels listed in FIG. 2, the “company.management” security label, granted to “user2,” may be compared to the “company.sales” security label in the security label table 116 to produce the comparison result 410. As mentioned previously, the comparison result 410 may be determined by applying preestablished access rules. In this example, the comparison result 410 indicates that the user should have read access but not write access to objects protected by the “company.sales” security label.

At run-time, a user may attempt to read or write to objects in the database using, for example, a SELECT, DELETE, UPDATE, or INSERT statement. If the objects are protected by a security label, the comparison results associated with the objects may be retrieved from the persistent label comparison results table 120. Access to the objects may then be granted or denied based on the comparison results rather than performing the comparison at run-time.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer-useable medium having a computer-readable program for improving label-based access control (LBAC) performance in a database, the operations of the computer program product comprising
assigning a security label to a user of a database, the security label being one of a plurality of security labels associated with a security policy of a database;
comparing the security label assigned to the user to each of the plurality of security labels to provide a plurality of comparison results;
storing the comparison results in a persistent label comparison results table for later retrieval;
receiving, from the user, a command to perform at least one of a read operation and a write operation on an object in the database;
retrieving, from the persistent label comparison results table, a comparison result associated with the object; and
controlling access to the object based on the comparison result.

2. The computer program product of claim 1, wherein the object is one of a row and a column in the database table.

3. The computer program product of claim 1, wherein the comparison results authorize at least one of read access and write access.

4. An database management system that improves label-based access control (LBAC) performance in a database by avoiding security label comparisons during runtime execution of database queries, the database management system comprising:
an assignment module to assign a security label to a user seeking to access a database, the security label being one of a plurality of security labels associated with a security policy of the database, the assignment module operating in response to a SQL statement initiated separate from runtime execution of database queries for the user;
a persistent label comparison results table to store the comparison results for later retrieval;
a comparator module to compare the security label assigned to the user to each of the plurality of security labels to provide a plurality of comparison results, the comparator module storing the plurality of comparison results in the persistent label comparison results table, the comparator module operating in response to a SQL statement initiated separate from runtime execution of database queries for the user;
a query module to receive, from the user, a SQL runtime command to perform at least one of read operation and write operation on an object in the database;
a retrieval module to retrieve, from the persistent label comparison results table, a comparison result associated with the object; and
a control module to control access to the object based on the comparison result.

5. The database management system of claim 4, wherein the object is one of a row and a column in the database.

6. The database management system of claim 4, wherein the comparison results authorize at least one of read access and write access.
